(19) United States
(12) Patent Application Publication
(10) Pub. No.: US 2007/0282679 A1
(43) Pub. Date: Dec. 6, 2007

(54) Coupon card for electronic redemption of product purchases

(76) Inventor: Norman Gable, Bryan, TX (US)

Correspondence Address: THE INVENTORS NETWORK, INC., 332 ACADEMY STREET, CARNEGIE, PA, 15106, US

(21) Appl. No.: 11/442,712

(22) Filed: May 30, 2006

(51) Int. Cl. G06Q 30/00

(52) U.S. Cl. 705/14

(57) ABSTRACT

A portable plastic coupon card having coupons digitally encoded thereon is swiped through a coupon reader that, along with other coupon readers, is electrically interconnected to a store server that stores and processes all purchaser data and coupon data for each individual issued one coupon card so that any item purchased by an individual and which corresponds to a particular digitally encoded coupon can be redeemed upon verification by the store server that the item is redeemable whereupon an electrical transmission from the store server to the particular checkout register causes that item to be redeemed and displayed as a coupon redeemable purchase on the printed receipt provided to the individual.

### FIELD OF THE INVENTION

The present invention pertains to a process and apparatus for the checkout counter redemption of price discounted items and products, and more particularly pertains to a system and method wherein an electronic coupon card is used for the immediate verification and redemption at the checkout counter of discounts on product purchases.

### BACKGROUND OF THE INVENTION

Coupon clipping and saving is a time-honored shopper practice and tradition. From the issuance and collection of Green Stamps several generations ago to the cutting and saving of paper coupons from newspapers, magazines and advertisement, the attempt and the desire to save money through the purchase of coupon discounted items and products is a long standing practice of the American consumer.

However, coupon shopping and saving requires a substantial investment of time in order to achieve real monetary savings in one's consumer purchases. First, one must carefully go through such sources as newspapers, advertisements, flyers and ads delivered by mail, and on site store distributed advertisements to determine what items and products are being offered at discounted prices and the expiration dates for those discounted items and products. The discount coupons must then be cut out and organized in some fashion. If the coupons are for grocery store purchases, the coupons can be organized into categories such as produce, meats, canned goods, breakfast cereals, etc. Most often the coupons are held together by nothing more than rubber bands or paper clips; though more industrious coupon savers organize their coupons on 3 by 5 inch note cards for storage in card boxes. The coupons are then stuffed into wallets, purses, back pockets or coat pockets when the individual visits a store offering the discounted items or products as indicated by the particular coupons. The appropriate coupons must then be located and fished out during the checkout of the items at the checkout register, and this can take some time as the coupons usually become disordered in the transport from the home to the store. Moreover, coupons are often left at home that could have been used for a store purchase or coupons are brought to the store that can't be used due to their expiration or the fact that the item is out of stock. Thus, while traditional paper coupon clipping and saving has been a time-honored consumer or shopper practice, its inconvenience has generated a search for a better and more efficient way to save money through coupon discounts. Thus, the prior art reveals a number of electronic, computer-based coupon generation and redemption methods and devices.

For example, the Humble patent (U.S. Pat. No. 4,949,256) discloses a coupon validation network that includes master files for recording the redemption of all coupons and the redemption of coupons by specific merchants, local control systems for participating merchants, and coupon processing terminals for reading the coupon account cards.

The Powell patent (U.S. Pat. No. 6,067,526) discloses a system and method for distributing coupons that includes a personal computer that receives information from a system of computer networks for creating a binary-formatted coupon that is then tangibly produced by a card-writing device for use by a customer at a participating store.

The Freeman et al. patent (U.S. Pat. No. 6,450,407 B1) discloses a method for providing advertisement information and rebates to a chip card containing a memory by downloading and storing information onto the chip card and then determining whether a rebate should be given after the purchase of a particular product.

The Walker et al. patent (U.S. Pat. No. 6,460,019 B1) discloses a system and method for tracking and confirming progressive consumer discounts and includes a point-of-sale controller that records and tracks a consumer's purchase to determine if a discount is allowable, and then increments by a pre-defined value the discount available for that customer on future purchases.

The Deaton et al. patent (U.S. Pat. No. 6,609,104 B1) discloses a system and method for accumulating marginal discounts includes processing customer purchases and then applying a marginal discount to the items purchased and also accumulating all unapplied marginal discounts for future application.

The Deaton et al. patent (U.S. Pat. No. 6,611,811 B1) discloses a system and method for accumulating marginal discounts so that a discount can be applied to the customer's order as a whole in response to a determination that the accumulated discounts exceed a predetermined minimum discount.

The Sanders et al. patent (U.S. Pat. No. 6,739,514 B2) discloses a sales transaction system with electronic coupon processing that includes a handheld optical code reader for scanning data on a paper coupon, and transmitting such data to a host computer for redeeming the product discount upon purchase of the item.

Nonetheless, despite the ingenuity of the above systems, methods and devices, there remains a need for an easy-to-use coupon card that provides immediate product discount information and redemption at the point-of-sale.

### SUMMARY OF THE INVENTION

The present invention comprehends a portable coupon card having a number of coupons corresponding to various items and products digitally and electrically encoded and stored thereon for reading by a checkout counter card reader. After the items or products are tallied and entered at the checkout register, the coupon card is swiped through a card reader. Both the checkout register and the card reader are electrically interconnected to a store server that verifies the particular card number of the coupon card and those purchases that are coupon redeemable. The store server sends an electronic transmission to the checkout register confirming the amount redeemable for each item that corresponds to that particular coupon. Items that are purchased and which are not coupon redeemable are simply tallied as normal purchases. A receipt then prints out showing the items purchased at standard, non-discount prices, and the items purchased having a coupon corresponding thereto and the price of the items after electronic coupon redemption. The final amount shown on the printed receipt reflects both the standard, non-discounted items and the coupon discounted items.

Purchasers can apply for the coupon card through a vendor working in conjunction with one or more stores in the particular sales region, and all relevant data (name, address, telephone number, drivers license number, email address, etc.) for each purchaser can be entered or inputted at a dedicated store PC. The information packet can then be sent via, for example, an Internet connection to an activation website where the information pertaining to each card purchaser is confirmed for coupon card activation. The coupon card can be digitally encoded with coupons for a particular item of one brand or product, or for storewide items that include numerous categories of brands and products. The coupon card can be encoded with coupons that are valid for a particular purchase period or more narrowly for seasonal and holiday periods. After all the coupons on the coupon card have been redeemed, or the valid period of use and coupon redemption has expired, the coupon card can be turned in for reformatting with new coupons and then reissued with a new set of digitally encoded coupons.

It is an objective of the present invention to provide a portable coupon card that includes digitally imprinted coupon discounts corresponding to various store products and items so that coupon discounts can be immediately redeemed at the checkout counter.

It is another objective of the present invention to provide a portable coupon card that can be reprogrammed and reissued with new coupons for a new coupon discount period after all the discounts have been redeemed for a previous discount period.

It is yet another objective of the present invention to provide a portable coupon card that can digitally encoded for storing discounts for particular categories of items and products or for storewide discounts of all inventory items and products.

Yet another objective of the present invention is to provide a portable coupon card that immediately registers any coupon discount upon being confirmed by a coupon card reader at the checkout counter.

Yet still another objective of the present invention is to provide a portable coupon card that eliminates the need to clip and organize paper coupons for presentation at the checkout counter.

These and other objects, features and advantages will become apparent to those skilled in the art upon a perusal of the following detailed description read in conjunction with the accompanying drawings and appended claims.

### BRIEF DESCRIPTION OF THE DRAWINGS

FIG. 1 is a perspective view of the portable coupon card of the present invention illustrating the creation and activation of a coupon card at the store site for a particular coupon card user;

FIG. 2 is a perspective view of the portable coupon card of the present invention illustrating the use of the coupon card for coupon redemption and the electronic verification and transaction through a store server for electronically redeeming the coupon for the particular item purchased;

FIG. 3 is a schematic representation of the portable coupon card of the present invention illustrating the steps by which the coupon card is reissued and reformatted for another period or cycle of coupon redemption by the specified user after the redemption of all the coupons previously encoded on the card;

FIG. 4 is a schematic representation of the portable coupon card of the present invention illustrating the use of a number of coupon cards at checkout counters of a store and showing the simultaneous electronic transmissions of coupon data from the coupon card, readers and the checkout registers to the store server for user verification and specific coupon redemption at the checkout registers; and

FIG. 5 is a schematic representation of the portable coupon card of the present invention illustrating a number of discounted items electrically encoded on the coupon card and the redemption at the checkout register of several purchased discounted items after verification by the store server.

### DETAILED DESCRIPTION OF THE PREFERRED EMBODIMENT

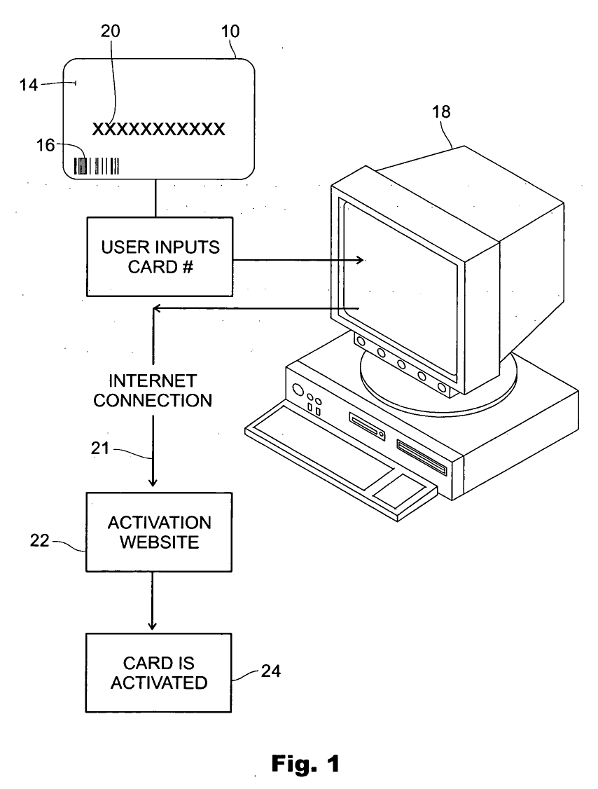

Illustrated in FIGS. 1-5 is a system and apparatus for obtaining discounts on the purchases of various items and products at grocery stores, shopping centers, drugstores, restaurants, retail stores, etc. by using a portable coupon card 10 that can be issued through the particular retail store for redemption at the checkout register. One or more stores can participate in the coupon card redemption, and the stores can cross brands and products, and include such participating stores as grocery stores, home improvement stores and retail stores. The coupon card 10 of the present invention is used to avoid the inconveniences and hassles of scanning newspaper and magazine ads for coupons, taking the time to clip the coupons out and organize them, and then transporting—in some form—the coupons to the store and retrieving them in an organized manner at the checkout register for obtaining redeeming the coupons and obtaining the desired discounts.

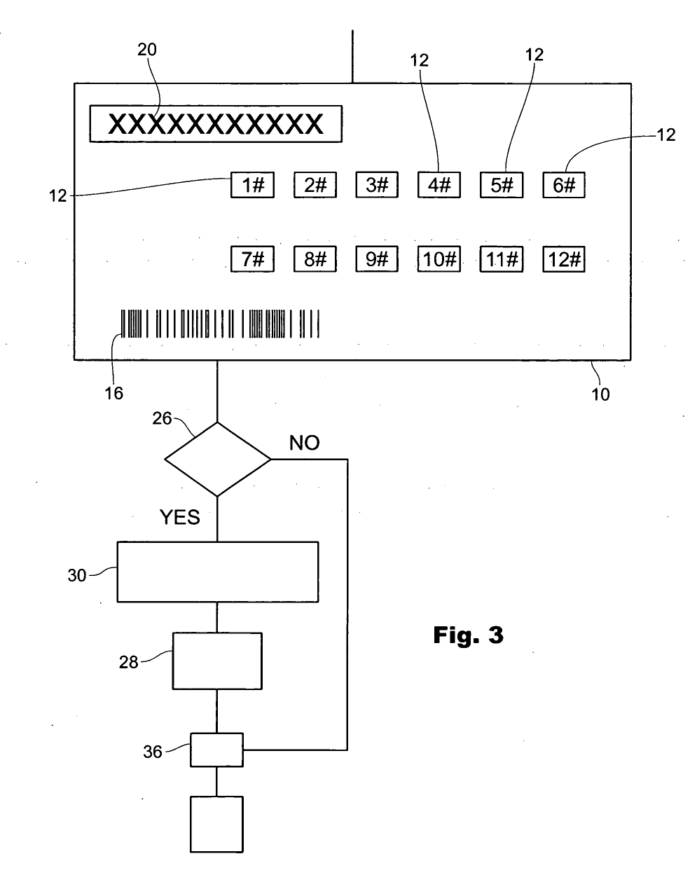

The coupon card 10 of the present invention can be issued in many different ways to the shopper or consumer from various sources, with the primary source being the particular retail store in conjunction with one or more primary suppliers or vendors. Thus, an individual will request the coupon card 10 and the coupon card 10 will have a number of coupons 12 digitally encoded and formatted on the backside 14 of the coupon card 10. FIG. 3 illustrates the digitally encoded and stored coupons 12 schematically arranged on the backside 14 of the coupon card 10. The coupons 14 are formatted for use within a given time period and thus includes an expiration date encoded thereon by incorporation in a UPC code 16. In addition, at a PC 18 dedicated for coupon card personal data entry, updating, reissuance, and other transactions, a store clerk can enter user data pertinent to the coupon card 10 such as card number 20, user address, user telephone number, user email address, user driver license number, etc. The information is entered at the PC 18 and then can be sent as a coupon card application data packet via an Internet connection 21 to an activation website 22 for electronic confirmation and verification. The coupon card 20 is then activated 24 after the appropriate confirmation and verification procedures, and this activation is communicated to the PC 18. The coupon card 10 can now be used for store purchases and applied to those items and products for which discounts are valid and obtainable.

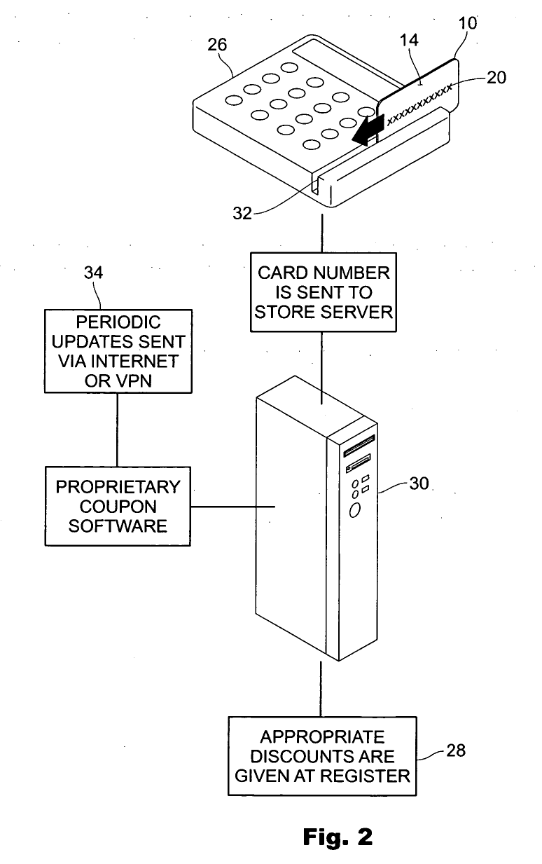

As shown in FIG. 2, the coupon card 10 is used in conjunction with a card reader 26, a checkout register 28 and a store server 30. The card reader 26 has a magnetic detection slot 32 through which the coupon card 10 is swiped for reading the coupon card 10, and the store server 30 includes proprietary software that stores and processes all coupon card 10 related data including requests for discounts electronically transmitted from the card reader 26 to the dedicated store server 30. In addition, periodic updates pertaining to the coupon cards 10 are sent to the store server 30 over the Internet 34.

As shown in FIGS. 2 and 3, the consumer or purchaser will make a number of purchases of items and products at, for example, a grocery store. Not all of the items and purchases will have discount coupons 12 associated with them. The cashier or check out clerk will enter all the purchases via the checkout register 28. The items purchased that do not have discounts associated therewith will be rung up and tallied at normal prices 36. The discounted items will also be rung as the items are successively rung up on the checkout register 28. By way of example, items may be purchased that correspond to discount coupons 1-4 12. After all the items have been rung up at the checkout register 28, the shopper swipes the coupon card 10 through the card reader 26. The card reader 26 electronically transmits to the store server 30 the card number 20 of that particular coupon card 10, and then the store server 30, through the proprietary software, matches the specific discount coupons 12 to the specific items rung up at the checkout register 28. The store server 30 then electronically transmits to the checkout register 28 the discount amount corresponding for that specific item. Finally, a cash register receipt 38 is printed out showing both the amounts for the non-discount purchased items 36 and the discount items to which the respective discount coupon 12 has been applied so that the regular price and the discount appear on the receipt 38. Thus, the cash register receipt 38 will reflect the total cash amount that will include the discounted price resulting from the use of one or more electronically redeemed coupons 12.

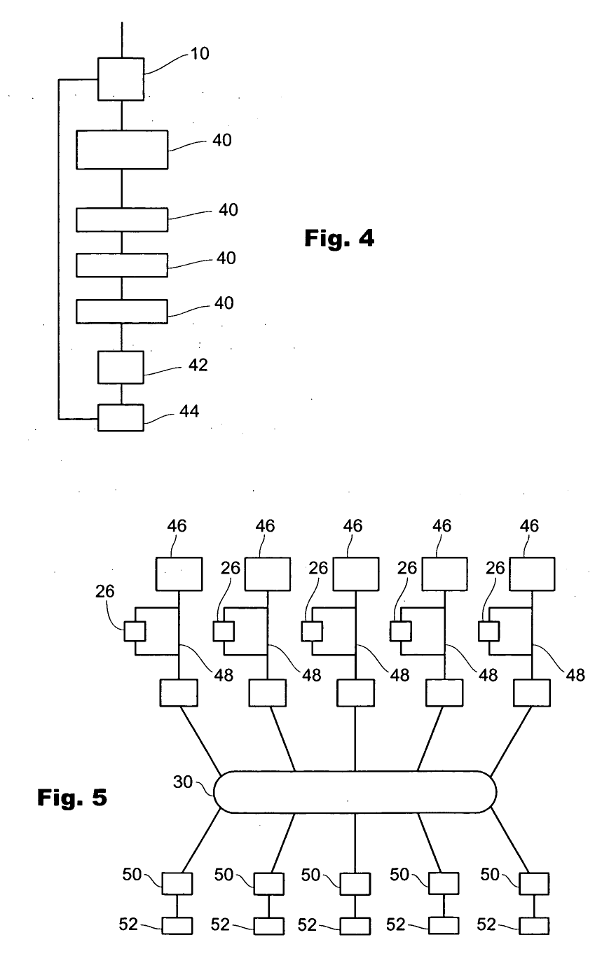

After all the coupons 12 on the coupon card 10 have been redeemed there needs to be a method or system for turning in the coupon card 10 so that the coupon card 10 can be reformatted with new coupons 12 for a new discount period and reissued to the selfsame individual. This allows the individual to keep the same coupon card 10 and also saves costs by avoiding the need to continually create new coupon cards 10 for each user after redemption of all the coupons 12 on the coupon card 10. Thus, FIG. 4 illustrates one method of coupon card 10 use and reissuance. The user of the coupon card 10 will, over a period of time, and within the expiration period of the card 10, redeem all the coupons 12 through a number of successive store shopping purchases 40. After all the coupons 12 have been redeemed, the individual will turn the coupon card 42 in for reformatting with new coupons 12; and this can be done through the dedicated PC 18 at the store, or the store can have an arrangement with the vendor whereupon the vendor reformats and reissues the new coupon card 44. The process of coupon card 44 verification and activation can then be undertaken as illustrated and aforedescribed in FIG. 1.

FIG. 5 is a schematic illustration of the simultaneous use a number of coupon cards 10 at a number of checkout registers 46 for the redemption of coupons 12 at the checkout registers 46. Five checkout registers 46 are represented with the non-discounted items or purchases being rung up on the cash registers 46 as normal purchases 48. Each checkout register 46 has a specific store number associated with it for identification and communication with the store server 30. After all the items have been rung up, including those items for which coupons are redeemable, the coupon cards 10 are swiped through the card readers 26, and the card readers 26 electrically transmit the respective card numbers 20 and the valid digitally encoded coupons 12 to the store server 30. The store server 30 then employs the proprietary coupon software to match up valid coupons 12 with the particular purchased items so that the specific coupon 12 can be redeemed for the corresponding specific item for each customer purchase. The discount amount for each item is then electrically transmitted to the corresponding checkout register 46 that initially rung the item up for the coupon redemption 50 of that item. Each checkout register 46 then prints out a final purchase receipt 52 that shows the amount for each non-discount item and the amount after coupon redemption for each store discount item having the redeemable coupon 12, and the final cash amount for all the item or products purchased.

While a preferred embodiment of the invention has been shown and described, it will become apparent to those skilled in the art that numerous modifications, alterations, or variations are possible and practicable while still remaining within the spirit of the invention and the scope of the claims appended hereto.

I claim:

1. A system for obtaining a discount for an item purchased at a store, comprising:
a coupon card having a backside for the digital encoding of a plurality of electronically redeemable coupons thereon;
a dedicated PC for entering user data pertinent for that coupon card including a card number associated with that respective coupon card;
an activation website electrically interconnected with the dedicated PC by an Internet connection for receiving transmissions from the dedicated PC pertaining to the data entered for that respective coupon card so that so that the data can be confirmed and the coupon card activated;
a store server electrically interconnected to the dedicated PC and the activation website for receiving updates for each coupon card and for the confirmation and storage of data pertaining to each coupon card;
at least one card reader electrically interconnected to the store server and having a magnetic detection slot through which the coupon card is swiped for electrically transmitting the card number and the coupons for that respective coupon card to the store server along with a list of both the coupon redeemable items and non-redeemable items associated with that respective coupon card; and
whereupon the store server matches the redeemable coupons to the respective items purchased and then electrically transmits this information to a checkout register so that the appropriate discounts are given at the checkout register for the items purchased and to which the redeemable coupons can be applied.

2. A method of reissuing a coupon card having a plurality of coupons digitally encoded thereon all of which have been redeemed through the successive purchases of items at a participating store with new redeemable couples, comprises:
turning in the coupon card at the participating store;
confirming the user data for the reissuance of the new coupon card by a dedicated PC located at the store;
transmitting the user data from the dedicated PC to a store server for confirmation and verification;
receiving the reissued coupon card containing the new redeemable coupons that are digitally encoded thereon; and
confirming the data on the reissued coupon card by the dedicated PC communicating with an activation website so that the reissued coupon card can be activated and used.
